(19) United States
(12) Patent Application Publication
(10) Pub. No.: US 2020/0387949 A1
(43) Pub. Date: Dec. 10, 2020

(54) COMPATIBILITY GUIDANCE METHOD FOR A MACHINERY PRODUCTS FOR AN IN-STORE AND ONLINE MARKETPLACE

(71) Applicant: Rohan Vishnubhai Patel, Bensalem, PA (US)

(72) Inventor: Rohan Vishnubhai Patel, Bensalem, PA (US)

(21) Appl. No.: 16/433,128

(22) Filed: Jun. 6, 2019

(51) Int. Cl. G06Q 30/06; G06Q 10/00

(52) U.S. Cl. CPC G06Q 30/0631; G06Q 10/20; G06Q 30/0641; G06Q 30/0627

(57) ABSTRACT

A compatibility guidance method to provide guidance to online customer about automotive accessory, parts for an online marketplace and in-store provides a combination of make, model and year of a machinery for customer to confirm particular universal automotive accessory's compatibility with given combination of vehicle during online shopping. By this process of providing compatibility guidance from premeasured data of vehicles saves a customer hassle of measuring and checking compatibility themselves. For in-store purchases a potential customer can be directed to a webpage where the potential customer can find compatibility guidance for a an automotive accessory, replacement automotive parts such as wiper blade, air filter or maintenance recommendation, related parts and tools required to perform specific repair or maintenance.

### CROSS-REFERENCE TO RELATED APPLICATIONS

This application is continuation-in-part of non-provisional application Ser. No. 15/715,775 filed on Sep. 26, 2017 which claims the benefit of U.S. Provisional Application No. 62/376,708 filed on Aug. 18, 2016 and U.S. Provisional Application No. 62/530,999 filed on Jul. 11, 2017, which is incorporated by reference herein.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF INVENTION

The present invention relates to check a compatibility of a replacement automotive parts or accessory to a specific vehicle for in-store shopping and online marketplace. Most automotive replacement parts' compatibility is being checked presently either by use of a manual or an electronic device present at the shelf. Most of the time customer's do not feel as confident using neither manual nor the electronic device. This method requires seller to make a guidance method on a webpage for all vehicles in advance and provide guidance to the customer and to provide assurance. A compatibility chart can help list out all the vehicles for customers to make sure before purchasing an automotive replacement parts like Engine air filter, cabin air filter, correct engine oil grade & type, spark plug, wiper blade, steering cover, car cover, license plate bracket, automotive sun shade, transmission fluid, tire, tool needed to perform specific repair, repair guidance etc. In this method an in-store customer is directed to a website where using a chart or a drop down selection menu customer can select a vehicle or an outdoor equipment they want to purchase a replacement part or accessory for and check compatibility online. Once the customer confirms the compatibility on a webpage, customer can choose correct part or accessory in-store and purchase if needed. This method makes process of checking compatibility hassle-free for the customer.

### BACKGROUND OF THE INVENTION

The present disclosure relates generally to replacement part or accessory for an automotive, indoor outdoor equipments such as lawn mower. Presently customer has to go through book which is generally hanging near shelf where customer can find the model of equipment or vehicle and find correct replacement maintenance parts or accessory for it. Sometime some stores have small electronic unit with data pre-recorded in it using which customer can find a correct part or accessory for equipment or a vehicle. Using both, booklet or electronic device required pre-printed or pre-installed data in them and usually cannot be updated over-night. Using present invention the in-store marketplace's potential customer is directed to a webpage. Since all data is loaded on a webpage, it easily can be updated overnight.

### DESCRIPTION OF RELATED ART

There are several types of compatibility methods in market for automotive/equipment part/accessory in-store but there isn't any method where in-store customer is guided on a webpage to check compatibility of any automotive/equipment part or accessory, thus present process involves customer to check compatibility using a booklet or using an electronic device usually mounted near shelf. A Compatibility guidance method to guide in-store customer to a webpage can save lots of time and mistakes made by consumers reading the booklet or electronic device.

However, conventional method to have customer read booklet or use electronic device is very inefficient and inaccurate if customer does not use either method properly. Also present compatibility method cannot be updated overnight.

### BRIEF SUMMARY OF THE INVENTION

A primary objective of the present disclosure is to guide in-store customer to a webpage to provide compatibility guidance for replacement part, maintenance part or accessory for automotive or equipment model.

### DESCRIPTION OF THE DRAWINGS

Having thus described the disclosure in general terms, reference will now be made to the accompanying figure, wherein:

FIG. 1 illustrates a guidance method 100 to help in-store customer by guiding customer to visit a website where he/she can check compatibility of part or accessory for any vehicle or equipment.

FIG. 2 illustrates a guidance method 200 to help in-store customer by guiding customer to visit a website where he/she can check compatibility of part for any vehicle or equipment using drop down menu or similar method to select a particular type of vehicle or equipment and find compatible part or accessory.

FIG. 3 illustrates a guidance method 300 to help in-store customer is guided to a webpage by scanning of barcode. By doing so customer does not need to type website; instead in-store scan the barcode in personal handheld device to get directed to a webpage were guidance can be provided.

FIG. 4 illustrates a guidance chart 400 to help in-store customer about few parts/accessories that would fit vehicle.

FIG. 5 illustrates a size guidance chart 500 to help customer choose closest size for a given vehicle, in accordance with an embodiment of the present disclosure; and

FIG. 6 illustrates a size guidance chart 600 with a list of vehicles that fits a given particular automotive accessory, in accordance with another embodiment of the present disclosure.

It should be noted that the accompanying figure are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

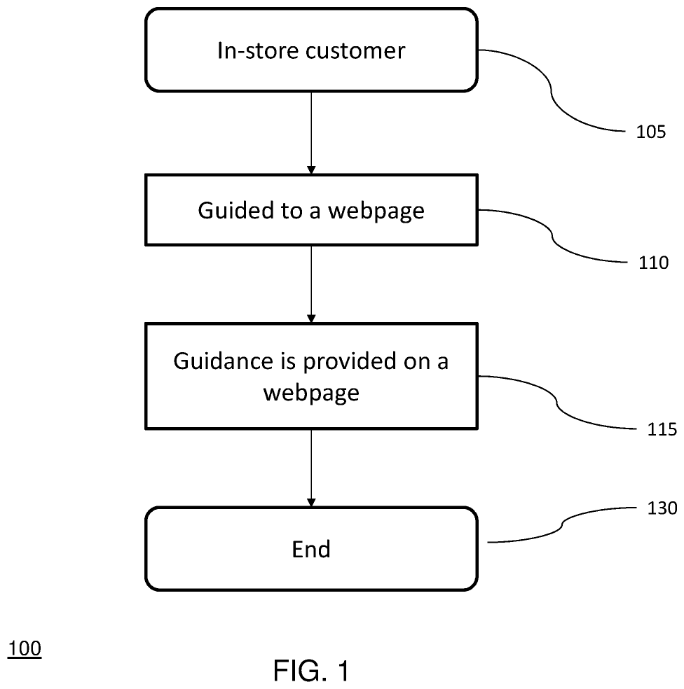

FIG. 1 illustrates a process 100 to guide in-store customer 105 to a webpage 110 where customer 105 can find compatible parts for a given vehicle or equipment 115. Then in-store customer 105 can make purchase of any suggested parts if needed.

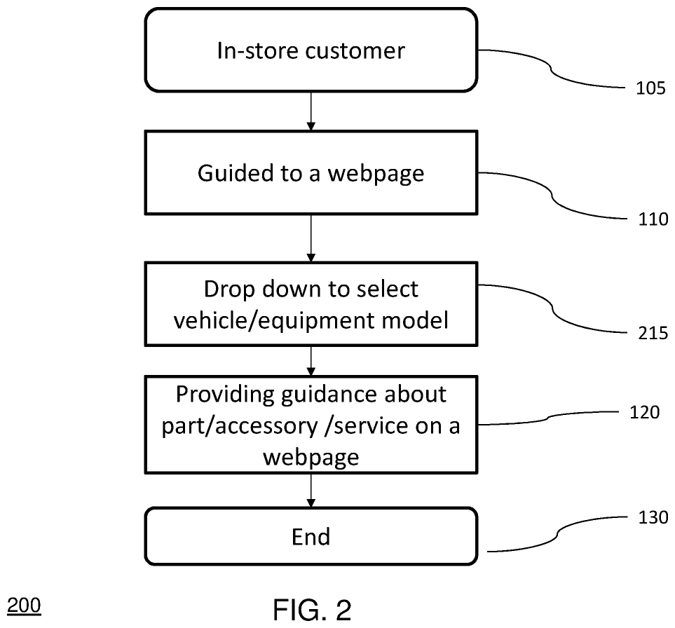

FIG. 2 illustrates a process 200 to guide in-store customer 105 to a webpage 110 where customer 105 can choose a vehicle or equipment using drop down menu 215 which then will populate all the parts or accessories that would fit for selected model. Then in-store customer 105 can make purchase of any suggested parts if needed.

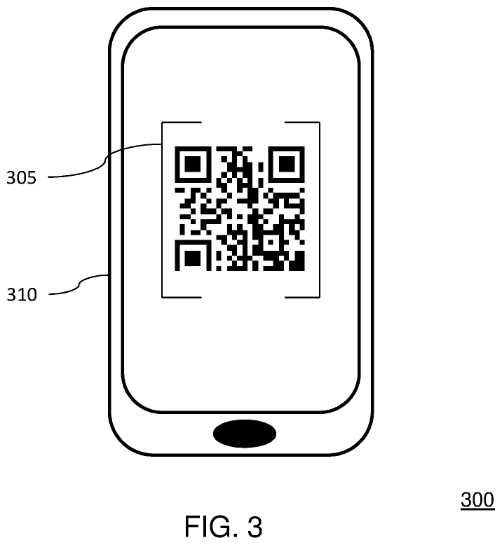

FIG. 3 illustrates a process 300 where in-store customer 105 is guided to a webpage 110 by scanning of a barcode 305 using a handheld personal device 310. By doing so customer 105 do not need to type anything, but just scan the barcode which will take user to the webpage 110 where the user can find a compatibility guidance. Then in-store customer 105 can make purchase of any suggested parts if needed.

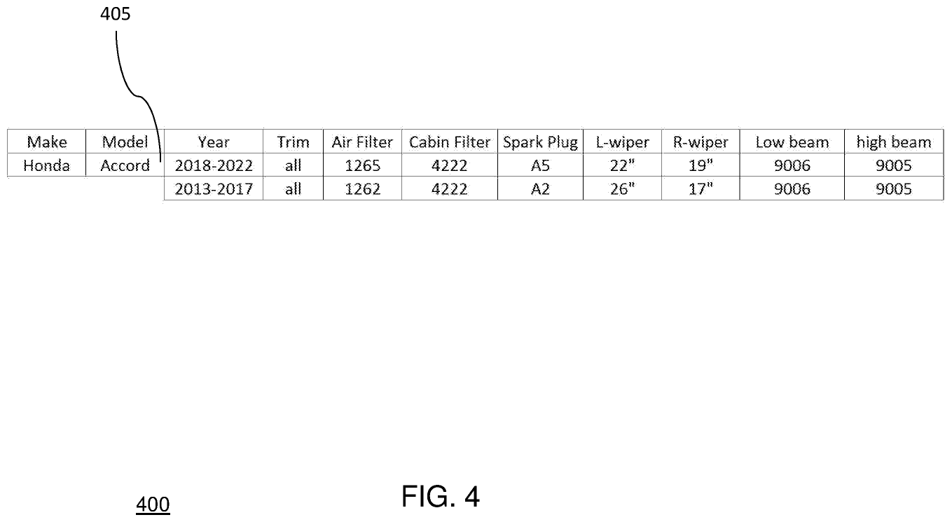

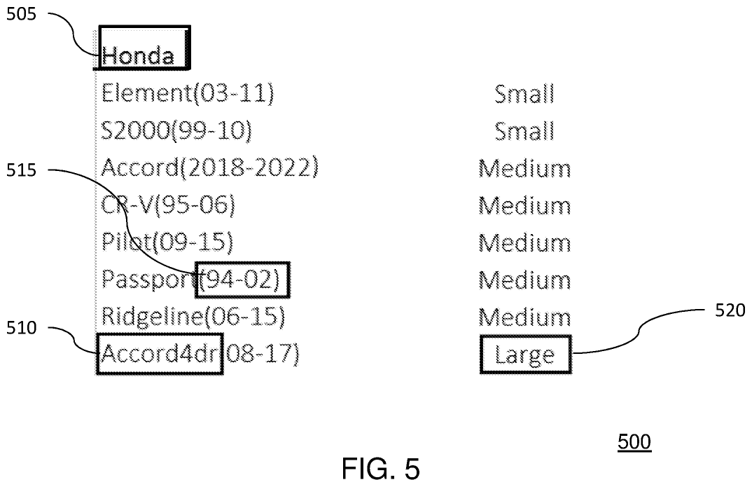

FIG. 4 illustrates a process an example of compatibility guidance chart 400 where in-store customer 105 is guided to a webpage 110 where for selected vehicle 405 all the compatible parts are populated. Then in-store customer 105 can make purchase of any suggested parts if needed. FIG. 5 illustrates a size guidance chart 500, in accordance with an embodiment of the present disclosure. The size guidance chart 500 allows a user select an appropriate size of a vehicle accessory for a particular maker and model of an automobile during online shopping or selection on a website. The size guidance chart 500 allows a user to find an appropriate size of an automotive accessory based on make, model and year of his automobile. For example, a vehicle accessory can be a windshield sunshade, side window sunshade or any other automobile accessory which is compatible to multiple vehicles.

The size guidance chart 500 has several vehicle models of an automobile manufacturer Honda but similar guidance chart can be made to guide customers to check compatibility of given automobile accessory to a specific vehicle model during their online shopping on a website. A maker 505 is shown to be selected as ‘Honda’. The size guidance chart 500 further has a model 510, which is shown to be ‘Accord4dr’. Further, the size guidance chart 500 also has year (range or standalone) 515. Year 515 is shown to 08-17 (2008 to 2017). Moreover, the size guidance chart 500 shows a size 520 of a sunshade. The size is shown to be ‘XL’. Based on the maker 505, model 510 and year 515, a user identifies an appropriate size of a sunshade for the automobile. For example, if a user has ‘Honda’ make, ‘Element’ model and a year being of year 2003 to 2011, an appropriate size of a sunshade is ‘Small’. In another example, if a user has a ‘Honda’ make, ‘Accord4dr’ model and a year being of year 2008 to 2017, an appropriate size for this particular vehicle is ‘XL’. It should be noted that the size guidance chart 500 is shown for illustration purposes only and does not limit the scope of the present disclosure. It will be apparent to a person ordinarily skilled in the art that the size guidance chart 500 is shown for illustration purpose only and can be appropriately modified to be used for online shopping. For example, a user can select a maker of an automobile, model and year for the automobile and type of window (windshield, door window and so forth) to see an appropriate size of an automobile accessory (such as a sunshade in 500) for the automobile.

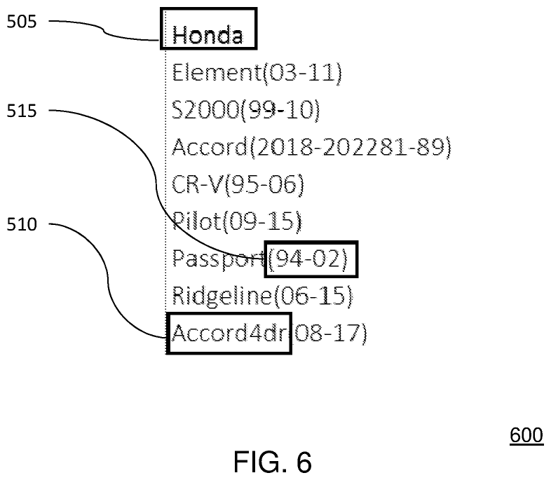

FIG. 6 illustrates a size guidance chart 600, in accordance with another embodiment of the present disclosure. The size guidance chart 600 shows a list of automobiles compatible to a given Automobile Accessory and list of vehicles that this given accessory is compatible which helps customer check compatibility of given product with their vehicle during online shopping on a website. The size guidance chart 600 is shown to be for a specific size of a sunshade as shown in FIG. 1. For a predefined size of a sunshade, the size guidance chart 600 shows make, model and years of compatible automobiles. It will be apparent to a person ordinarily skilled in the art that the size guidance chart 600 is shown for illustration purpose only and can be appropriately modified to be used for online shopping. For example, a user can select a size of an automobile accessory (such as a sunshade in 500), a maker, model and year for the automobile compatible the selected size of accessory can be displayed to user.

Present disclosure provides several advantages over existing art. It allows customer to check compatibility of given accessory without measuring their vehicle hassle-free.

Present disclosure provides several advantages over existing art. It allows in-store customer to check part's compatibility to given automotive or equipment or wise versa.

Present disclosure provides several advantages over existing art. It allows in-store customer guided to a webpage where service related information including video guidance and tools needed to perform specific task can be suggested which will provide hassle-free experience for customer and increase revenue of a store at the same time.

Present disclosure provides several advantages over existing art. It can also be set-up to allow in-store customer to the guidance team through a webpage where the guidance team can guide in-store customer where in customer can find parts, accessories that would be compatible for given automotive vehicle or a machinery including but not limited to garden and house hold equipments. Customer also can be provided a picture of a machinery in order to pick correct model where possible.

1. A guidance method for suggesting compatibility on an online marketplace comprising:
a. listing at least one of the following automotive accessories on an online webpage;
1 at least one automotive window accessory that does not come with a vehicle from factory;
2. at least one automotive storage accessory;
3. at least one automotive steering accessory;
4. at least one automotive license plate accessory;
5. at least one automotive sun visor accessory;
6. at least one automotive mobile device accessory;
7. at least one automotive mirror accessory;
8. at least one sun shade accessory;
b. suggesting compatibility of an automotive accessory using at least one make and at least one model wherein the user can check compatibility for an accessory that is not custom made for a specific vehicle model.

2. The guidance method of claim 1, wherein the guidance provided includes providing a list of compatible vehicles for the accessory.

3. The guidance method of claim 1, wherein the guidance provided based on an input by the online user for at least one vehicle.

4. The guidance method of claim 1, wherein the guidance provided includes providing compatibility information on window snow cover's compatibility for a given vehicle.

5. The guidance method of claim 1, wherein the guidance provided by populating at least one compatible accessory based on the user input of at least one vehicle.

6. The guidance method of claim 1, wherein the guidance provided includes providing a guide about compatible vehicles for the automotive storage product's compatibility.

7. The guidance method of claim 1, wherein the guidance provided includes providing a guide about compatible vehicles for a steering wheel accessory to a given vehicle.

8. The guidance method of claim 1, wherein the guidance provided includes providing compatibility guidance for sun visor accessory to a given vehicle.

9. The guidance method of claim 1, wherein the guidance provided includes providing compatibility guidance for a license plate accessory to a given vehicle.

10. The guidance method of claim 1, wherein the guidance provided includes providing compatibility guidance for a windshield glass related accessory to a given vehicle.

11. The guidance method of claim 1, wherein the guidance provided includes providing compatibility guidance for a mobile device related accessory for a given vehicle.

12. A guidance method for suggesting compatibility of a machinery product for an in-store shopper including the following steps:
a. directing the in-store shopper to a webpage;
b. suggesting guidance of at least one of following on a webpage;
1. at least one automotive accessory;
2. at least one automotive replacement part;
3. at least one automotive service;
4. at least one machinery part;
5. at least one tool to perform service;
6. at least one HVAC replacement part.

13. The guidance method of claim 12, wherein the guidance is provided includes a list of compatible vehicles.

14. The guidance method of claim 12, wherein the guidance provided by populating at least one compatible accessory based on the user's input of at least one vehicle.

15. The guidance method of claim 12, wherein the guidance is provided for an automotive sun shade.

16. The guidance method of claim 12, wherein the guidance is provided using drop down to select the vehicle on a website.

17. The guidance method of claim 13, wherein the guidance is provided for a pet accessory's compatibility with the vehicle.

18. The guidance method of claim 12, wherein the guidance provided includes providing compatibility guidance for an automotive license plate accessory with the vehicle.

19. The guidance method of claim 12, wherein the guidance provided includes compatibility guidance for an automotive steering cover for the vehicle.

20. The guidance method of claim 12, wherein the guidance provided includes providing compatibility guidance for an automotive storage accessory for the vehicle.

21. The guidance method of claim 12, wherein the guidance provided includes providing compatibility guidance for an automotive sun visor accessory for the vehicle.

22. The guidance method of claim 12 includes providing compatibility of an Air Filter with the vehicle.

23. The guidance method of claim 12 includes providing compatibility information of a wiper blade for the vehicle.

24. The guidance method of claim 12 includes providing compatibility information on compatible spark plug for the vehicle.

25. The guidance method of claim 12 includes providing a guide about for a maintenance intervals.

26. The guidance method of claim 12 includes providing a guide about compatible for engine oil change service.

27. The guidance method of claim 12 includes providing a guide about compatible part for at least one model of house-hold equipment.

28. The guidance method of claim 12 includes providing a guide about compatible part for at least one model of outdoor equipment.

29. The guidance method of claim 12 includes providing guidance of at least one of tools needed to perform the service and/or repair.

30. The guidance method of claim 12 includes providing guidance to perform the service using a video on the webpage.
